(19) United States
(12) Patent Application Publication
(10) Pub. No.: US 2023/0024451 A1
(43) Pub. Date: Jan. 26, 2023

(54) ENHANCED GRADIENT MARKER CREATING VARIOUS TONES

(71) Applicant: Xavier Dillard, Plano, TX (US)

(72) Inventor: Xavier Dillard, Plano, TX (US)

(21) Appl. No.: 17/858,137

(22) Filed: Jul. 6, 2022

Related U.S. Application Data
(60) Provisional application No. 63/221,469, filed on Jul. 13, 2021.

(51) Int. Cl. B43K 17/01; B43K 1/01

(52) U.S. Cl. CPC B43K 17/01; B43K 1/01

(57) ABSTRACT

This disclosure describes systems, methods, and devices related to enhanced gradient marker. A device may comprise a marker housing. The device may an ink retardant nib having a marker tip, wherein the ink retardant nib restricts flow of ink, and wherein the ink retardant nib comprises a tapered end designed to be inserted in the marker housing. The device may an ink retardant nib head shaped to provide ink application through a barrier.

### CROSS-REFERENCE TO RELATED PATENT APPLICATION(S)

This application claims the benefit of U.S. Provisional Application No. 63/221,469, filed Jul. 13, 2021, the disclosure of which is incorporated by reference as set forth in full.

### TECHNICAL FIELD

This disclosure generally relates to systems and methods for markersand, more particularly, to an enhanced gradient marker creating various tones.

### BACKGROUND

A permanent marker is a marking device that can only create a single tone. Using a single-toned marker is limiting to artists because it stops a creator from using the tool to sketch and tone build, which are both crucial foundations to all visual art.

### BRIEF DESCRIPTION OF THE DRAWINGS

FIG. 1 depicts a side view of the ink retardant marker nib, in accordance with one or more example embodiments of the present disclosure.

FIG. 2 depicts a three-quarter top view of the ink retardant marker nib, in accordance with one or more example embodiments of the present disclosure.

FIG. 3 depicts a three-quarter back view of the ink retardant marker nib, in accordance with one or more example embodiments of the present disclosure.

FIG. 4 depicts a front view of the ink retardant marker nib, in accordance with one or more example embodiments of the present disclosure.

FIG. 5 depicts a disassembled side view of an enhanced gradient marker, in accordance with one or more example embodiments of the present disclosure.

FIG. 6 depicts a disassembled side view of an alternate marker, in accordance with one or more example embodiments of the present disclosure.

FIG. 7 depicts an assembled side view of the enhanced gradient marker, in accordance with one or more example embodiments of the present disclosure.

FIGS. 8-11 depict illustrative schematic diagrams for enhanced gradient marker, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in or substituted for, those of other embodiments. Embodiments set forth in the claims encompass all available equivalents of those claims.

Today's marker only presents a single workaround to tone building through a mark-making process called cross-hatching. While cross-hatching can be effective, it is a time-intensive process, and it is the only way a marker can present the illusion of tone building. The use of this new gradient marker, which is primarily meant for use by artists, will release the limit of the permanent marker and bring it closer to other fine art tools by allowing an artist to utilize a marker in a similar manner to dry media art tools (e.g., pencil, charcoal, Conte, etc.) in order to build real tones. Furthermore, no marker exists that allows an artist to sketch by using light tones. While there are markers that are called “sketch markers” these markers are just normal markers with thinner marker nibs that are used to make thinner lines. But by using an enhanced gradient marker, an artist will be able to sketch with a wet media tool (e.g., markers, paint) for the very first time.

Today's markers only create one type of mark. Traditionally, this limitation is overcome by utilizing different mark-making techniques like hatching. This however is only a workaround that does not alter the fact that a marker can only produce a singular bold mark.

Markers are made to have a consistent flow to ensure a certain kind of mark. An enhanced gradient marker creates a restriction to the marker flow that results in an inconsistent flow of ink. By using time as a device with the marker, that the artist can have fine-tuned control over the tone of the marks that the marker tool creates.

Ordinarily, a fibrous nib is used with permanent markers because it creates a constant flow. The gradient marker uses a porous nib created not to release dense ink and it is being paired with permanent marker which results in inconsistent flow. This combination of the hard-shelled barrier and the porous tip creates a resistant flow from the marker device that the user can control using time applied. More layers of the hard-shelled barrier can be applied to create a marker that is hard I.e. the marker produces lighter marks and does not get extremely dark, which is great for sketching. Using few layers or no hard-shelled barrier all can create a soft marker. I.e. the marker produces darker marks and does not get extremely light. General, a well-balanced mid-tone marker can be created by using only 1 or 2 layers.

It is known that permanent markers are great wet media tools because they do not make a mess and are long-lasting. Artists also use them to build confidence in drawing due to their permanent nature. The gradient marker makes use of these points and adds more utility to the mix by releasing the tool of its only limiting factor. It is known by a select few artists that it is possible to expand the use of a marker by using markers that are about to die out, but these markers do not last long due to them being at the end of their life; meanwhile the gradient marker has a long lasting life span and is readily available so the user does not need to spend days, weeks, months or years to achieve this marker's desired effect. It is known that Artline's “Dry safe” markers have a specialized ink that, when exposed to air, produce a soft membrane that “surrounds the nib and keeps the marker from drying out without a cap for up to 48 hours.” The soft membrane will then break when the use of the marker is resumed. Ultimately, both the ink retardant nib in the gradient marker and the Artline marker utilize a protective surface to a marker nib. The dry safe Artline markers are an improvement to ink technology as it is a specialized ink that prevents the marker from drying out. An enhanced gradient marker focuses on an improvement to the technology in a marker nib resulting in the creation of the ink retardant marker nib. The dry safe marker creates a membrane that breaks upon contact and is only there to sustain the marker life in case the marker is left without a marker cap. In contrast, an enhanced gradient marker uses a hard friction-resistant barrier that is constructed to make contact on the paper without breaking to cause a resistance between the applicator and the writing surface while also plugging extra orifices. Lastly, the barrier on the enhanced gradient marker does not prevent marker dry out but it slows it down compared to other ink makers.

Example embodiments of the present disclosure relate to systems, methods, and devices for marker apparatus using ink retardant nib that creates various tones through time applied.

In one embodiment, an enhanced gradient marker system may facilitate improvement to the marker applicator (e.g., marker nib) which will restrict flow to the marker's tip; allowing the user the ability to control how much ink is released from the ink retardant nib by adjusting the time applied from the marker device to the desired surface. Ordinarily, markers are produced to always create a consistent bold mark. This improvement, which focuses on resistance to the marker's tip, allows time to be added as the factor to give precise control over the tool to create various gradient effects. The resulting tool not only saves paper from being worn down from too much ink exposure to a marking surface, but this creates a marker that can be used similarly to traditional dry media art tools such as graphite, charcoal, Conte, etc. The ink retardant nib is comprised of a porous, sponge-like material, adjusted for use for liquid-based utilities, like a highlighter. This is important because while other types of nibs can be used, it is beneficial to use a nib created not to release a dense amount of ink. The porous nib is then coated in a semi-permeable, friction-resistant, hard-shell plastic barrier. This barrier not only adds increased resistance to the marker nib but also helps regulate the ink flow to keep the marker from overflowing while the device is not in use. Moreover, adding additional layers of the barrier to the nib will allow the manufacture the ability to create marker nibs of various innate hard and soft properties similar to hard and soft graphite pencils (I.e. adding more barrier layers means increasing hardness, the relative lightness of the marker; while having few to no barriers will increase the softness, the relative darkness of the marker). The ink released from the ink retardant nib is generally light and functions through time variables. By increasing the amount of time applied to the desired application surface; more ink will be released through the barrier resulting in a variance of tone. The marker device creates marks on a page by sweeping over a surface; as such, slowing down the sweeping motion allows the marker to get darker. Increasing the mark-making speed allows for lighter marks the user can use to create sketches. The user can continue to reapply the marker to fine-tune the tones and layer down more gradients.

In one or more embodiments, an enhanced gradient marker system may use a porous sponge-like nib that does not release dense ink.

In one or more embodiments, an enhanced gradient marker system may use a semi-permeable shell that encases the nib that acts as a barrier to reduce the amount of ink released from the marker as well as help stop the marker from bleeding when not in use. The Marker nib may be friction-resistant. The ink retardant nib functions through time variables. More ink can be released by increasing the time the marker is applied to the surface. Less ink can be released by decreasing the time the marker is applied to the surface. The marker normally supplies a light mark because of its restrictive nature. Because this marker uses less ink, the marker does not oversaturate and ruin the drawing surface. Adding and removing layers to the barrier can create various markings with various innate tones similar to graphite pencils.

In one or more embodiments, an enhanced gradient marker system may facilitate new or different mechanisms. For example, the use of an ink retardant nib. The ink retardant nib enables the user to use time as a basis to have fine-tuned control over the amount of ink released from the marker to create various gradient effects. Use of a porous nib intended for highlighter being used as a base for a permanent marker nib.

Typically, markers and permanent markers only create a single tone. If the markers are about to die, the markers get lighter, causing the user to have to build up a marker to create the original desired effect. If careful enough, a lighter mark may be created with a permanent marker, however, doing so takes considerable control and the final product will lack fine-tuned mid-tones that the new ink retardant marker nib can create.

In one or more embodiments, an enhanced gradient marker system may comprise a marker that can be composed of a plastic pen tube, cap, reservoir core, after plug and soft-shelled ink retardant nib. Alternatively, it can also be composed of a plastic pen tube, pen mouth, cap, reservoir core, and soft-shelled ink retardant nib. The overall shape of the marker can vary; however, it is generally cylindrical. The cap is adapted to attach to the mouth of the marker housing the marker nib. One embodiment of the marker nib may be a porous sponge-like material that is modified to not release a dense amount of ink. The head of the ink retardant porous nib is encased in a soft-shell barrier that is semipermeable and resistant to friction that could possibly be composed of a plastic material (it should be noted that it is also possible that the outer barrier on the tip can also serve to plug some of the internal orifices in the porous marker tip adding to the restricted flow in the ink retardant tip.) The tip extends from the marker mouth as the applicator to the desired drawing or writing surface. The marker creates marks by using sweeping motions across a surface and the type of mark can be changed by adjusting the amount of time the nib is applied to a surface. Increasing time applied to the surface from the retardant nib creates an increasingly darker-toned mark. Decreasing the time applied from the ink retardant nib creates a light-toned mark. Varying levels of tones can be created by using various combinations of techniques ranging from different combinations of time. The nib can be any shape; however, it is shown to be a chisel tip for ease of illustration. The chisel tip nib shape allows the user to vary line width for sketching and tone-building purposes by either using the very tip of the chisel or by using the entire head of the nib. Adjusting the angle of the nib allows for a variation of line width created from the marker. The marker body is generally a cylinder that houses an interior marker reservoir that fits within the body. The contents of the reservoir can vary; however, it is normally composed of fibrous material and the ink could be any ink however it is recommended to be an alcohol-based permanent marker ink. If the marker has an after plug, it is fitted to attach to the bottom end of the marker, opposite of the end with the cap and marker tip. If the marker has a detachable mouth, then it is fitted to insert into the top of the marker. That is the part of the marker that will be used to create marks on a surface.

The state of the art may use separate toned markers. However, this is cumbersome because a user may need to keep up with multiple markers to create a single gradient. These markers can also be blended to create gradations by either using special ink or by using a colorless blending marker. Another option may be to modify the number of pours in a marker to create a flow that is restricted enough that it gives the desired effect without the use of a barrier. However, in order to create a range of sketch markers, this will be costly to always modify and improve each one. Additionally, the barrier stops the marker from bleeding out a dark ink every time the marker is first used after being stored. While it might be possible to engineer such a marker without the bleed, the barrier is the quicker and more cost-effective solution.

In one or more embodiments, an enhanced gradient marker may use ink that dries lighter than when applied. A marker could utilize ink that is able to become lighter when applied to the desired marking surface. This however requires a wait time when drawing and sketching that would be tedious.

In one or more embodiments, applications could be created to dry out the marker before use. Also, it is possible to dry out a marker every time one wanted to use the marker to sketch or to create a gradient with a marker by drying out the marker by leaving it exposed to air or UV light. However, this effect will only last a brief amount of time until the marker recovers.

In one or more embodiments, an enhanced gradient marker system may facilitate creating an ink compound that when the marker comes in a contact with air, the marker creates a semi-permeable hard-shell barrier that encloses the marker applicator. This is useful because the marker's hard-shelled barrier is ever broken, the user can always create a new marker. However, this will not be useful with markers that use multiple barriers.

In one or more embodiments, an enhanced gradient marker system may facilitate omitting the use a porous nib. A fiber nib can be used. However, the porous nib is more effective for marker restriction and works better with the barrier.

In one or more embodiments, an enhanced gradient marker system may facilitate using ink that could be created that allows for layering by using ink that applies onto the surface as a naturally translucent ink but it becomes more opaque as some kind of force (ink/friction/pressure, etc.) is applied to it.

In one or more embodiments, an enhanced gradient marker system may facilitate using a mechanism that dilutes the pen before use. Either the main embodiment or a separate mechanism can be created that dilutes the ink that then allows the artist to draw with lighter/restricted/translucent ink.

In one or more embodiments, an enhanced gradient marker system may facilitate using less densely packed nib. Any nib can appear restricted if the contents of the nib are parted enough (for example if a fiber-tipped nib were to use a frayed tip). However, these nibs will be hard to control from the artist.

In one or more embodiments, an enhanced gradient marker system may facilitate creating a mechanism that can squeeze out more or less ink from a pen. A mechanism can be created that can be twisted/pulled/pressed/squeezed/scrolled/switched to create a restriction to create a lighter mark that can then be used to build tone.

In one or more embodiments, an enhanced gradient marker system may facilitate a mechanism to dilute ink within a pen. Another pen can be used as a diluting device to lighten ink already applied to the surface.

In one or more embodiments, an enhanced gradient marker system may facilitate a mechanism to lighten ink within pen before application to paper. A pen could be created to dilute the page before the application of marker ink. This marker will make it so the ink applies lighter than its base tone.

In one or more embodiments, an enhanced gradient marker system may facilitate a mechanism to lightly erase ink in a subtractive method.

A mechanism or a separate embodiment can be created to lightly erase ink created by a marker. The ink could be erased in a manner to create the desired effect.

In one or more embodiments, an enhanced gradient marker system may facilitate an ink-resistant fiber nib. A nib could be created from fibers that are naturally resistant to the marker so that it creates a restricted mark.

In one or more embodiments, an enhanced gradient marker system may facilitate fiber that dries ink before releasing it. A marker can be created where the fibers in the marker nib can dry out the marker ink before, during, or after, the ink is applied to the page.

In one or more embodiments, an enhanced gradient marker system may facilitate the creation of a fiber or plastic that stubbornly holds ink. A fiber or plastic can be used for the tip of the marker that is able to hold ink but is stubborn to release it to a surface.

In one or more embodiments, an enhanced gradient marker system may facilitate the use of paper that reacts with ink. Paper could be created that reacts to marker in a way that the ink dries lighter or darker than what is applied.

In one or more embodiments, an enhanced gradient marker system may facilitate the creation of a marker that releases valve ink upon time and/or pressure applied. A marker device could be created that when the user presses upon the instrument, it can release a valve to dispatch a specific amount of ink to the marker nib. This could make a marker that can create light and dark marks based on pressure and/or time.

In one or more embodiments, an enhanced gradient marker system may facilitate a marker device that can transferred ink that has already been applied to a page. A marker device can be created that only picks up excess ink from a page and reapplies it elsewhere. This will offer some degree amount of control over the tone of the marker ink.

In one or more embodiments, an enhanced gradient marker system may facilitate a marker to enhance UV light to create dried-out marker. UV light can and will dry out a marker. An embodiment can be created that can create/use/enhance UV light to dry out the marker, either before, during, or after its use.

In one or more embodiments, an enhanced gradient marker system may facilitate placing a barrier around the paper to filter the ink. A barrier can be placed between the marker and the writing surface that can be used as a filter device for the marker to restrict how much ink is applied to the page.

In one or more embodiments, an enhanced gradient marker system may facilitate transferring ink from one paper to another. A marker could be created that could pick up ink from paper and reapply to a new location on a paper. This new mark will be lighter.

In one or more embodiments, an enhanced gradient marker system may facilitate a barrier that can lower ink released from inside the pen. An internal barrier could be added within the pen to slow the release of the ink.

In one or more embodiments, an enhanced gradient marker system may facilitate the use of a different shaped marker tip instead of a chisel tip. Although an embodiment uses a chisel tip marker any marker tip shape can be used.

In one or more embodiments, an enhanced gradient marker system may facilitate a double-sided white dark or light marker. The marker could be created to be double-sided with one marker being lighter-toned and the other marker being darker toned. The two inks could be created to mix so they can be layered to make different tonal greys. This is also possible with two separate markers that or either black and white or light and dark. Additionally, this could be used with any color marker.

In one or more embodiments, an enhanced gradient marker system may facilitate a multicolored marker. A single embodiment could house multiple inks. Allowing the user to click and switch between multiple inks housed inside the marker.

In one or more embodiments, an enhanced gradient marker system may facilitate change out ink in the marker using cartridges. A marker could use varying tonal inks by having a mechanism that allows for easy and quick changes between the different color ink tones.

In one or more embodiments, an enhanced gradient marker system may facilitate a marker that lightens the ink as building over it. A marker focuses on making ink darker, but ink could be created to lighten as more ink is applied to the page.

In one or more embodiments, an enhanced gradient marker system may facilitate a marker that embodies black and white and/or grey ink that can be mixed together while inside the pen to create different tone variations.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

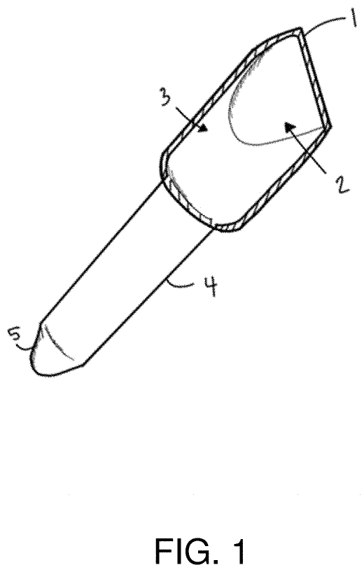

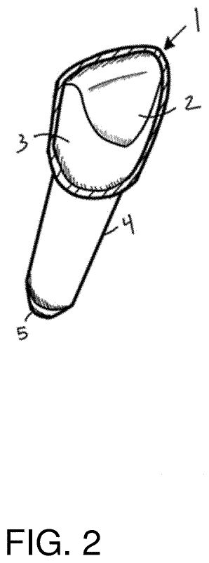

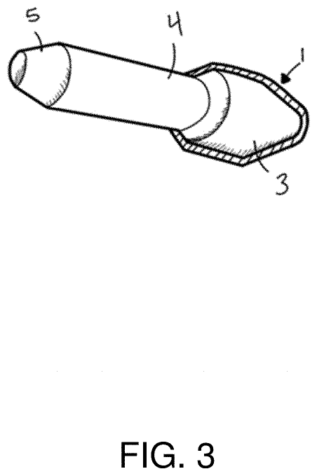

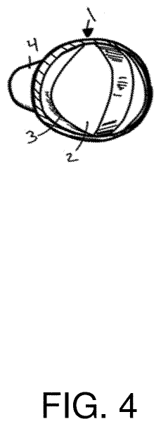

FIG. 1 is a side view of the ink retardant marker nib. FIG. 2 is a three-quarter top view of the ink retardant marker nib. FIG. 3 is a three-quarter back view of the ink retardant marker nib. FIG. 4 is a front view of the Ink retardant marker nib.

Element 1 is the semi-permeable, friction-resistant, hard-shell plastic barrier. Element 2 is the tapered portion of the chisel tip nib. Element 3 is the entire head of the chisel tip, note that only the head of the nib may need to be coated in the plastic barrier. Element 4 is the nib's body (e.g., the trunk). Element 5 is the end of the ink retardant nib, designed to insert into the marker's reservoir.

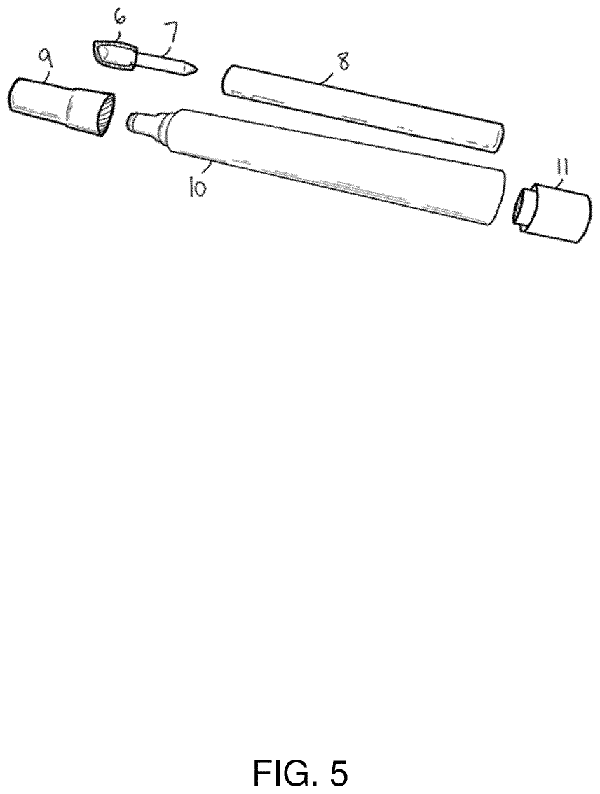

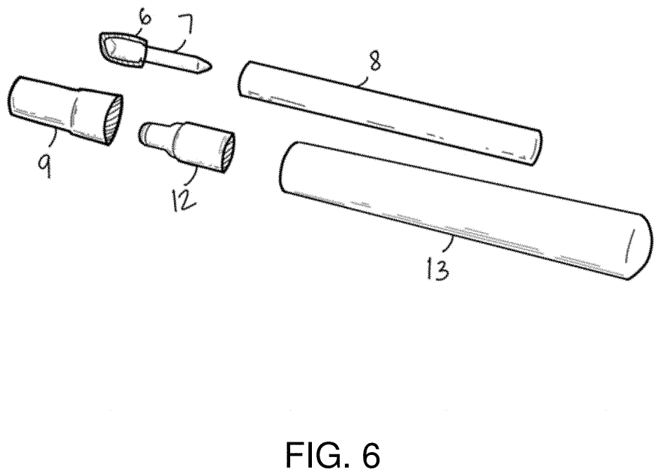

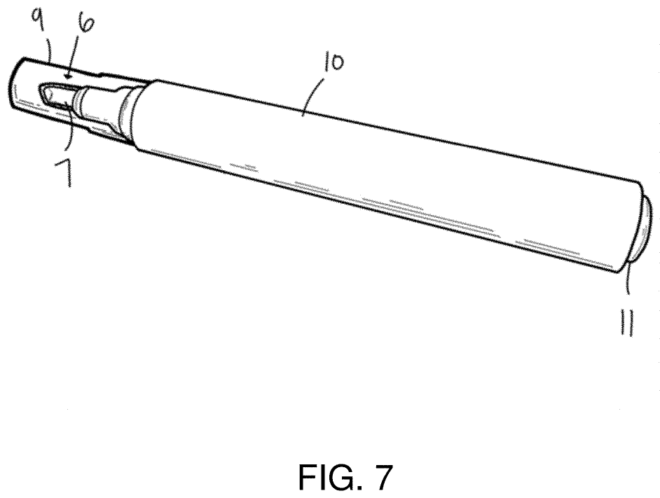

FIG. 5 is a disassembled side view of an enhanced gradient marker embodiment. FIG. 6 is a disassembled side view of an alternate marker embodiment. FIG. 7 is an assembled side view of the enhanced gradient marker embodiment.

Element 6 is the semi-permeable, friction-resistant, hard-shell plastic barrier. Element 7 is the ink retardant nib. Element 8 is the ink reservoir that is placed within the marker's body. Element 9 is the market cap. Element 10 is the marker body with the mouth attached. Element 11 is the marker's after plug, meant for use for markers without a detachable mouth. Element 12 is a detachable marker mouth, meant for use for markers without a detachable after plug. Element 13 is a marker body with no detachable after plug.

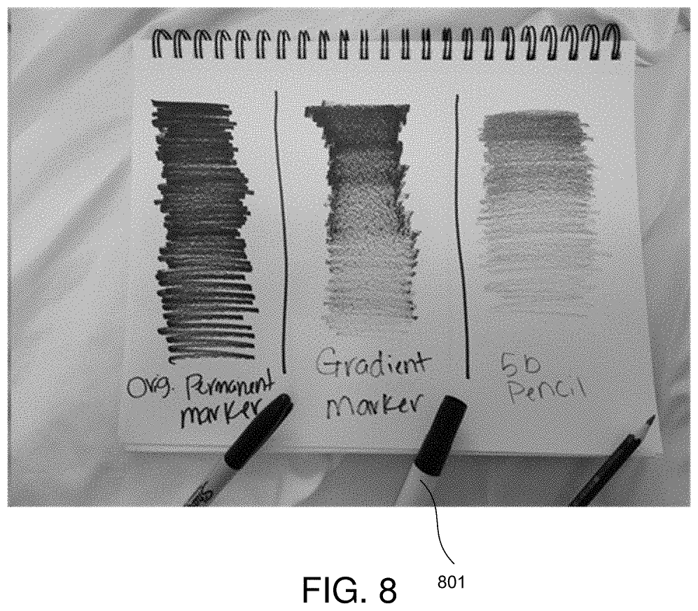

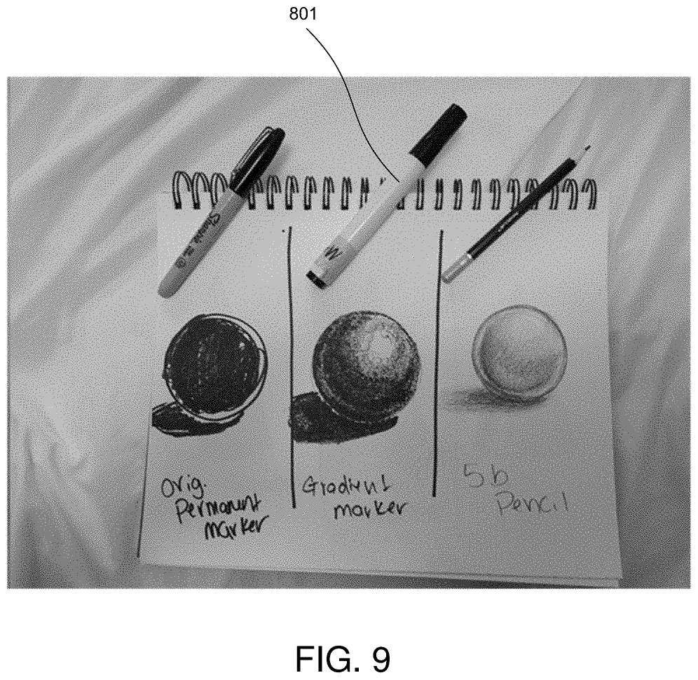

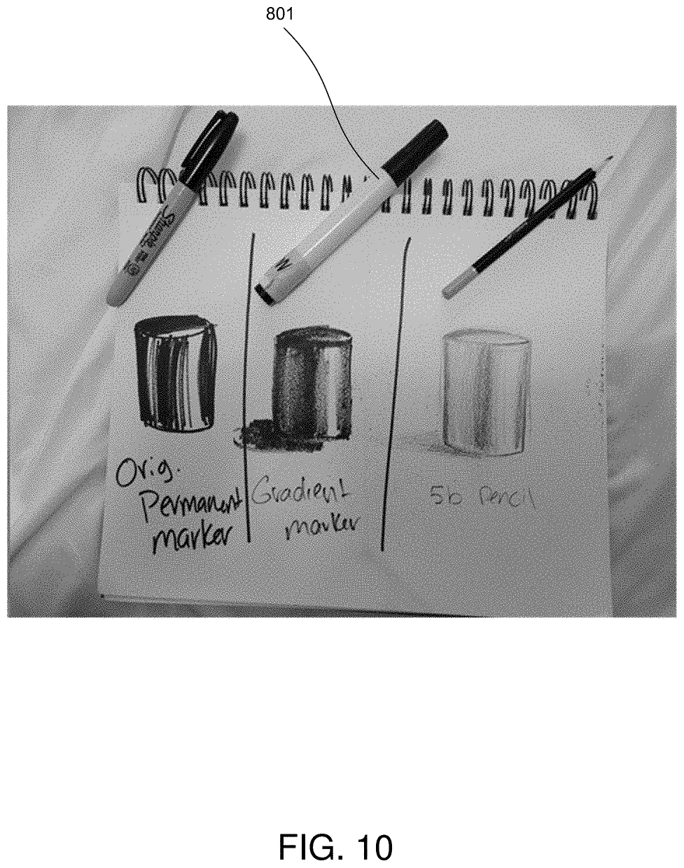

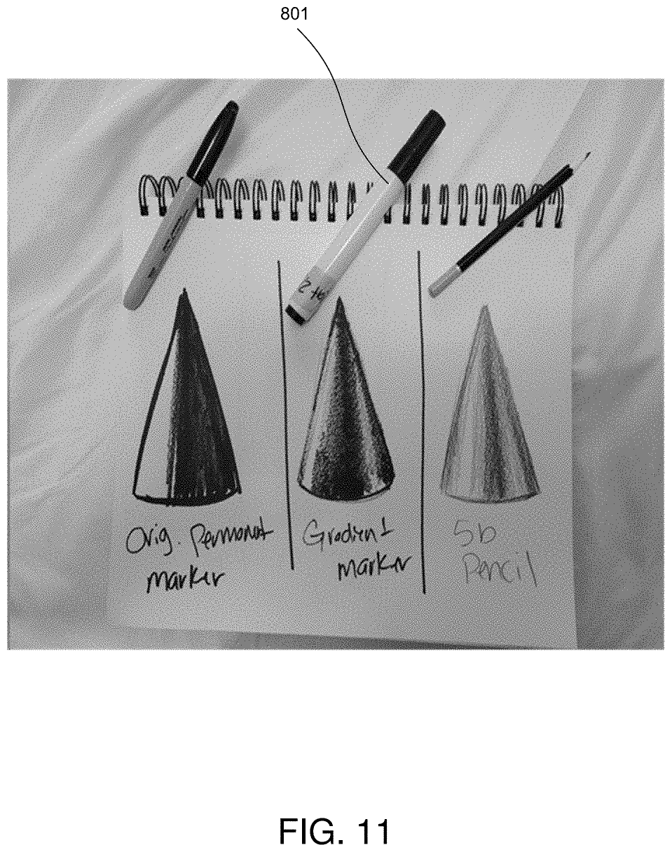

FIGS. 8-11 depict illustrative schematic diagrams for enhanced gradient marker, in accordance with one or more example embodiments of the present disclosure.

The enhanced gradient marker 801 is comprised of a marker body, marker cap, and after plug. Inside the marker is a cotton reservoir containing colored ink. The porous nib may be coated in a thin layer of plastic glue structure called “Dimensional magic” mod podge (though any mod podge can work to varying degrees). The mod podge dries as a clear plastic around the nib that helps restrict the flow for two reasons. Reason one, it provides a plastic barrier shell that ink needs to seep through in order to mark the page. Reason two, the glue-like plastic seeps inside the sponge-like pores of the nib to close off some of the orifices thus restricting ink flow.

It is understood that the above descriptions are for purposes of illustration and are not meant to be limiting.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An enhanced marker system comprising:
a marker housing;
an ink retardant nib having a marker tip, wherein the ink retardant nib restricts flow of ink, and wherein the ink retardant nib comprises a tapered end designed to be inserted in the marker housing; and
an ink retardant nib head shaped to provide ink application through a barrier.

2. The enhanced marker system of claim 1, wherein the barrier is a semi-permeable barrier.

3. The enhanced marker system of claim 1, wherein the barrier is a hard-shell plastic barrier.

4. The enhanced marker system of claim 1,wherein the marker housing comprises an ink reservoir.

5. The enhanced marker system of claim 1, wherein the barrier encases the marker tip.

6. The enhanced marker system of claim 1, wherein the barrier reduces an amount of ink released from the marker housing to a surface.

7. The enhanced marker system of claim 1, wherein the barrier allows a release of an amount of ink based on an amount of time the marker is applied to a surface.

8. The enhanced marker system of claim 1, wherein the marker tip is a chisel shape.

9. An ink marker comprising:
a marker housing;
an ink retardant nib having a marker tip, wherein the ink retardant nib restricts flow of ink, and wherein the ink retardant nib comprises a tapered end designed to be inserted in the marker housing; and
an ink retardant nib head shaped to provide ink application through a barrier.

10. The ink marker of claim 9, wherein the barrier is a semi-permeable barrier.

11. The ink marker of claim 9, wherein the barrier is a hard-shell plastic barrier.

12. The ink marker of claim 9,wherein the marker housing comprises an ink reservoir.

13. The ink marker of claim 9, wherein the barrier encases the marker tip.

14. The ink marker of claim 9, wherein the barrier reduces an amount of ink released from the marker housing to a surface.

15. The ink marker of claim 9, wherein the barrier allows a release of an amount of ink based on an amount of time the ink marker is applied to a surface.

16. The ink marker of claim 9, wherein the marker tip is a chisel shape.

17. A ink retardant nib configured to restrict flow of ink, the ink retardant nib comprising:
a marker tip;
an ink retardant nib head shaped to provide ink application through a barrier; and
a tapered end configured to be inserted in a marker housing;

18. The ink retardant nib of claim 17, wherein the barrier is a semi-permeable barrier.

19. The ink retardant nib of claim 17, wherein the barrier is a hard-shell plastic barrier.

20. The device of claim 17, wherein the barrier encases the marker tip.
